(19) United States
(12) Patent Application Publication
(10) Pub. No.: US 2011/0004745 A1
(43) Pub. Date: Jan. 6, 2011

(54) Method of Controlling a Measurement Instrument

(75) Inventor: SHINOBU KUBOTA, Kanagawa (JP)

Correspondence Address: WILLIAM K. BUCHER;TEKTRONIX, INC., 14150 S.W. KARL BRAUN DRIVE, P.O. BOX 500, MS 50-LAW, BEAVERTON, OR, 97077, US

(73) Assignee: TEKTRONIX INTERNATIONAL SALES GMBH, Rheinfall (CH)

(21) Appl. No.: 12/823,034

(22) Filed: Jun. 24, 2010

(30) Foreign Application Priority Data
Jul. 1, 2009 (JP) 2009-157251

(51) Int. Cl. G06F 15/177; G06F 1/32

(52) U.S. Cl. 713/1; 713/320

(57) ABSTRACT

A method of controlling a hibernation mode for a measurement instrument comprising a computer system and a computer system is provided. In a case that a power switch is turned off in a hibernation mode, contents of a memory of the computer system is transferred to a non-volatile storage device such as a hard disk drive unit under control of an operating system of the computer system and a power circuit of the measurement instrument is turned off. In a case that the power switch is turned on in the hibernation mode, the power circuit is turned on, the transferred contents stored in the non-volatile storage device is transferred to the memory under control of the operating system and the measurement device is initialized under control of application software and data stored in the memory.

### BACKGROUND OF THE INVENTION

The present invention relates to a method of controlling a measurement instrument including a computer system controlled by an operating system and a measurement device controlled by the computer system.

There are many kinds of measurement devices, such as oscilloscopes, logic analyzers, spectrum analyzers, signal generators, video test instrument, network monitoring/diagnostic systems, network analyzers and the like. In a conventional measurement instrument, a measurement function, a signal generation function, a test function, a diagnostic function and the like of the measurement device are directly controlled by a build-in central processing unit (CPU) and program (firmware) stored in a read only memory (ROM). Recently, one type of measurement instruments, the measurement device is not controlled by the firmware but is integrated with a general-purpose computer system. In another type of the recent measurement instruments, the measurement device is coupled with a computer system, such as a personal computer (PC) that controls the measurement device. In such recent measurement instrument, the computer system is controlled in accordance with general-purpose operating system, such as Microsoft® Windows®.

An example of such measurement instrument is shown in FIG. 1. A measurement instrument 10 comprises a CPU or a microprocessor 14, a random access memory (RAM) 16, a hard disk drive unit 18 as a non-volatile storage device, a display device 20, such as a liquid crystal display device, and an input device 22, such as a keyboard, a mouse and the like, which are coupled with each other through a bus 12. The hard disk drive unit 18 stores an operating system and application software for the measurement. These blocks 14 through 22 form a computer system. The bus 12 is coupled with a measurement device 24 that may be one of the above described measurement devices. For example, the measurement device 24 may be an arbitrary waveform signal generator wherein a signal is generated by an FPGA (field programmable gate array) 26 and many kinds of setup parameters are stored in a register 28. A power controller 30 controls on and off states of a power supply circuit (not shown) by using a power switch 32. If necessary, a ROM may be provided for storing software of starting the CPU 14.

When the power switch 32 is turned on, the power controller 30 receives an on-command from the power switch 32 and starts up the power circuit to produce voltages to be applied to each block. The CPU 14 recalls the operating system stored on the hard disk drive unit 18 to start its operation. The CPU 14 transfers initialization data and application software stored on the hard disk drive unit 18 to the RAM 16 under control of the operating system. The initialization data transferred to the RAM 16 is used to initialize the FPGA 26 and the register 28 in the measurement device 24 under control of the application software. These operations accomplish the preparation of the arbitrary signal generator as the measurement device 10. An operator inputs the setup parameters for a desired signal to the FPGA 26 and/or the register 28 through the RAM 16 by manipulating the input device 22 while monitoring the input data with the display device 20. Digital waveform record data is generated from the setup parameters and stored in the FPGA 26. The FPGA 26 of the measurement device 24 generates the desired signal from the digital waveform record data. It should be noted that the RAM 16 stores the same data as the data stored in the FPGA 26 and the register 28 of the measurement device 24.

A general-purpose operating system, such as Windows of Microsoft Corporation, has a resume function. The resume function comprises a suspended mode, and a hibernation mode. In the suspended mode, after the power switch 32 is turned off, the minimum power from the power circuit is still applied to maintain the data on the RAM 16 of the computer system. Thus, the data, which is stored in the RAM 16 just before the power switch is turned off, still remains on the RAM 16. When the power switch 32 is turned on, the RAM 16 stores the data without transferring the data from the hard disk drive unit 18 to the RAM 16. Therefore, the start-up time of the computer system is improved although the power is always consumed. On the other hand, in the hibernation mode, after the power switch 32 is turned off, the computer system transfers the contents (including the data and application software) of the RAM 16 to the hard disk drive unit 18 and turns the power circuit off under control of the operation system. After that, when the power switch 32 is turned on so as to activate the power circuit, the contents of the RAM 16 transferred to the hard disk drive unit 18 at the last turn-off time is transferred back to the RAM 16 of the computer system under control of the operating system so that the contents of the RAM 16 is the same as one just before the power switch is turned off. Therefore, in the hibernation mode it is possible to turn the power circuit completely off after the power switch is turned off. However, the recovery speed of the hibernation mode is slower than that of the suspended mode.

Since a conventional resume function is based on the operating system of the computer system, this function affects only the computer system. Therefore, in a measurement instrument having the computer system, if the hibernation function of the operating system is available, the data in the RAM 16 (including the duplicated FPGA 26 and register 28 data) in the computer system transferred to the HDD 18 can be recovered to the original state so that the contents saved at the power-off time can be recovered when the computer system is turned on. However, the computer system does not transfer the recovered FPGA 26 and the register 28 data saved at the last power-off time to the FPGA 26 and register 28, so that the data on the RAM 16 does not match the data in the FPGA 26 and the register 28. As a result of this mismatch, the measurement device may make an error in operation. In order to avoid the malfunction, a conventional measurement instrument disables the resume function of the operating system so as not to use this function. In other words, when the power switch is turned on, the conventional measurement instrument always initializes both the computer system and the measurement device in accordance with initialization data, but it cannot recover the original operating condition at the last turn-off time.

U.S. Pat. No. 5,748,971 to Choi et al. issued May 5, 1998 entitled “Option Card Hibernation System” discloses a computer system having a slot for an option card. This computer system improves a recovery speed from the hibernation mode. When recovering from the hibernation mode, a RAM and a graphic card are initialized and the dedicated software is called by BIOS to initialize the option card. Thus, it is necessary to develop the dedicated initialization software for the hibernation function. If the measurement instrument is being manufactured for a long period, a version of BIOS may be changed. In this case, the new BIOS should be verified whether it meets the dedicated initialization software or not. This is troublesome for a manufacturer.

What is desired is a measurement instrument comprising a computer system and a measurement device and being able to use a hibernation mode in an easy approach.

### SUMMARY OF THE INVENTION

Accordingly, the present invention provides a method of controlling a measurement instrument that includes a measurement device and a computer system. According to an embodiment of the present invention, the computer system includes a central processing unit or microprocessor, a memory such as a random access memory, and a non-volatile storage device such as a hard disk drive unit wherein the computer system works under control of an operating system. When a power switch is turned off in a hibernation mode, the contents (including data and application software) of the random access memory is transferred to the non-volatile storage device under control of the operating system and then a power circuit of the measurement instrument is turned off. When the power switch is turned on in a case that the hibernation mode is selected at the last power-off operation, the power circuit is activated, the saved contents on the non-volatile storage device is transferred to the random access memory under control of the operating system, and the measurement device is initialized under control of application software and the data stored in the random access memory. When the power is turned on in a case that the last power-off is in a normal mode, the power circuit is activated, initialization data stored in the non-volatile storage device is transferred to the random access memory and the measurement device is initialized in accordance with the initialization data and application software.

The present invention can use the hibernation mode of a general-purpose operating system, such as Microsoft® Windows® and does not need to consider a BIOS version, so that it is easy to apply the hibernation mode to the measurement instrument. In addition, power consumption for the measurement instrument can be saved and the measurement instrument can be recovered quickly to the original condition when a power switch is turned on.

The objects, advantages and other novel features of the present invention are apparent from the following detailed description when read in conjunction with the appended claims and drawing.

### BRIEF DESCRIPTION OF THE DRAWING

FIG. 1 is a block diagram of a measurement instrument comprising a measurement device and a computer system to which an embodiment of the present invention is applied.

FIG. 2 is a flow chart for explaining an operation when a power switch is turned off in accordance with the embodiment of the present invention.

FIG. 3 is a flow chart for explaining an operation when the power switch is turned on in accordance with the embodiment of the present invention.

FIG. 4 is a flow chart for explaining an operation of a timer routine used to determine whether the power supply is turned off in the hibernation mode and then it is turned on.

### DETAILED DESCRIPTION OF THE INVENTION

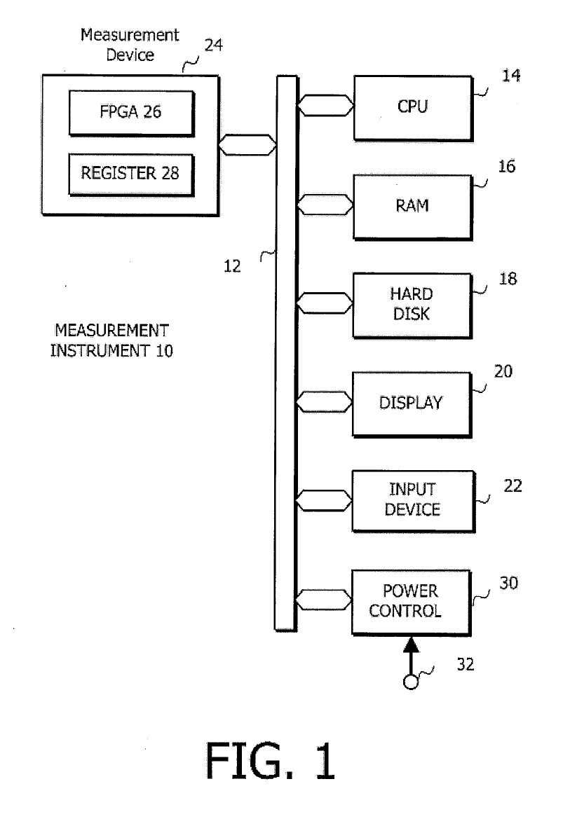

A method for controlling a measurement instrument according to an embodiment of the present invention can be applied the measurement instrument configured as shown in FIG. 1. As will be described in detail hereinafter, when the measurement device 24 starts its operation by turning the power switch 32 on in a normal mode, the operating system and the application software are loaded from the hard disk drive unit 18 to the RAM 16 and various kinds of setup parameters are loaded from the input device 22 to the RAM 16. The data stored on the RAM 16 is transferred to the register 28 and controls the generation of the digital waveform record data and the configuration of the FPGA 26 so that the measurement device 24 works the desired operation. The display device 20 displays the setup information and the operation condition of the measurement device 24 in a conventional manner. Therefore, the digital waveform record data for the FPGA 26 and the setup data stored on the register 28 are memorized by the RAM 16.

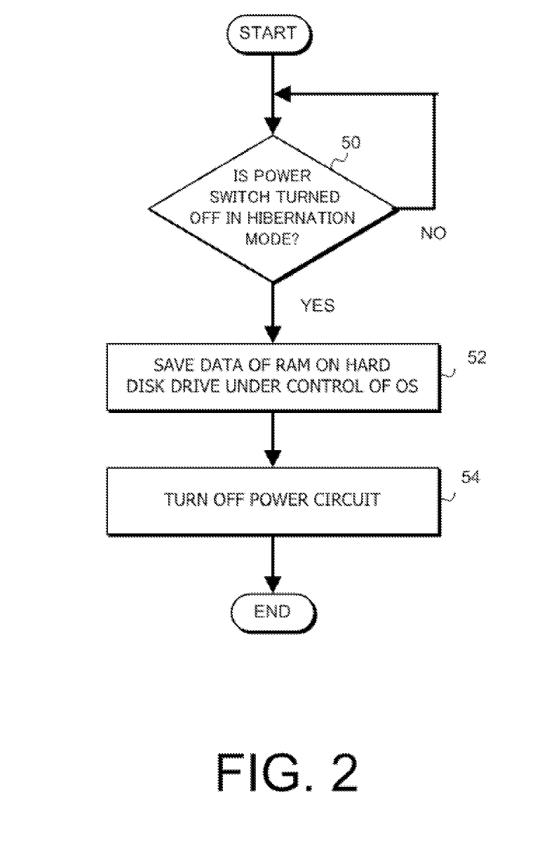

FIG. 2 is a flow chart for explaining an operation of the embodiment according to the present invention when the power switch is turned off. The following operation is controlled by the CPU or microprocessor 14 in accordance with software. In a step 50, the computer system monitors the condition of the power switch 32 through the power controller 30 to determine whether the power switch 32 is turned off in the hibernation mode. If the power switch 32 is not turned off in the hibernation mode (“NO”), the process returns to the step 50. If the power switch 32 is turned off in the hibernation mode (“YES”), the procedure proceeds to a step 52 wherein the contents of the RAM 16 (including the duplicate FPGA 26 and register 28 data and the application software stored in the RAM 16) are transferred to the hard disk drive unit 18 and saved on the hard disk drive unit 18 under control of the operating system (OS). After completing the step 52, the process proceeds to a step 54 wherein the operating system turns the power circuit (not shown) off through the power controller 30.

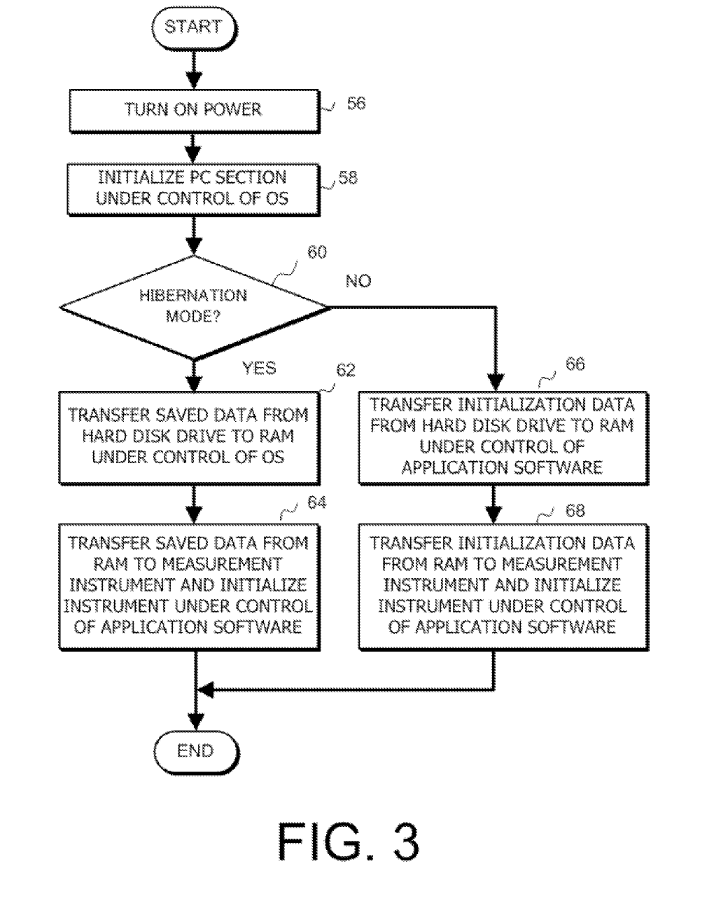

FIG. 3 shows a flow chart for explaining an operation when the power switch is turned on. When the power switch 32 is turned on in a step 56, the power supply circuit starts up. The process proceeds to a step 58 wherein the operating system stored in the hard disk drive unit 18 is called to initialize the computer system (PC section). The process goes to a step 60 to determine if the hibernation mode is selected or not at the last power-off time. The operation of the step 60 will be described in detail hereinafter. If the decision result at the step 60 is “YES” (i.e. the hibernation mode is selected), the process proceeds to a step 62. In this step, the data (including the FPGA 26 and register 28 data and the application software) transferred to the hard disk drive unit 18 from the RAM 16 at the last turn-off time is transferred from the hard disk drive unit 18 to the RAM 16 under control of the operating system. After that, the process goes to a step 64. The recovered data saved in the RAM 16 is transferred to the FPGA 26 and the register 28 in the measurement device 24 under control of the application software to restore the measurement device 24 to its state before the hibernation shutdown. This recovery returns the measurement device 24 quickly to its condition at a time when the power switch 32 is turned off.

If the step 60 determines that the hibernation mode is not selected (“NO”), the process goes to a step 66 wherein the initialization data is called from the hard disk drive unit 18 and transferred to the RAM 16 under control of the application software. Then, the process proceeds to a step 68. The initialization data stored in the RAM 16 is transferred to both the FPGA 26 and the register 28 of the measurement device 24 so as to initialize the measurement device 24 under control of the application software. In this case, the initialization sets up condition of the measurement device 24 to initial values or default values regardless of the condition at a time when the power switch 32 is turned off. The operation of these steps 66 and 68 is the same as the conventional power-on operation of the measurement instrument.

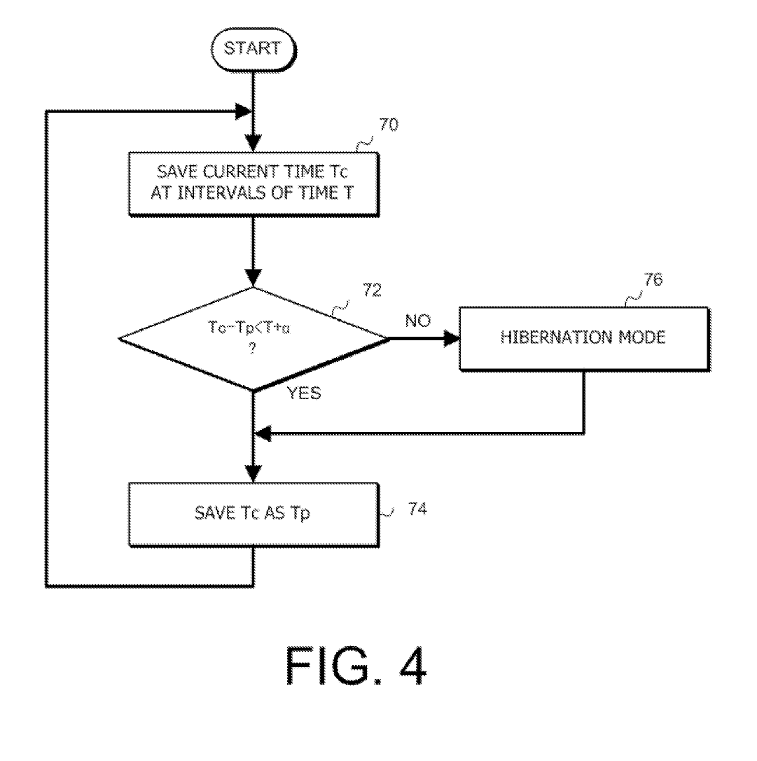

FIG. 4 illustrates a flow chart for an operation of the step 60. This flow chart shows a timer routine that determines whether the power is turned off and then turned on in the hibernation mode. In a step 70, a current time is detected every interval T and the detected time is defined as Tc. The PC section has a clock to measure the time. Assuming that Ts is a time period for recovering the operating system from the turn-on time from the hibernation mode to an operable time and Tf is a time period necessary for entering to the hibernation mode (sleep mode) after turning the power switch off in the hibernation mode, the time interval T is less than Ts+Tf, which is represented by T<Ts+Tf. A step 72 determines if a time relation of Tc−Tp<T+α is satisfied or not. Tp represents a time when the last timer routine is executed and α represents a margin. If a determination result of step 72 is YES, it means that the power is not off in the hibernation mode and the process proceeds to a step 74 wherein Tc is saved as Tp. Then, the process returns to the step 70. It should be noted that if the power is turned off between the time Tp and the time Tc, Tc−Tp is longer than T+α. If the result of the step 72 is “NO”, which means that the power is turned off in the hibernation mode, the process goes to a step 76 wherein the computer system recognizes the power is turned off the hibernation mode. Then, the process proceeds to the step 74 so as to save Tc as Tp and return to the step 70.

Although the preferred embodiment incorporating the teachings of the present invention has been shown and described in detail herein, those skilled in the art will readily understand that many other varied embodiments would still incorporate these teachings. For example, the present invention may be applied to many kinds of measurement devices, such as oscilloscopes, logic analyzers and the like instead of the signal generator. The initialization information for the measurement device may be stored on a read only memory (ROM) and this ROM may be mounted in the measurement device. In this case, the initialization information is called from the ROM instead of the hard disk drive unit. Various kinds of nonvolatile semiconductor memories may be used instead of the hard disk drive unit.

What is claimed is:

1. A method of controlling a measurement instrument including a measurement device and a computer system coupled with said measurement device through a bus, comprising the steps of:
in a case that a power switch is turned off in a hibernation mode, transferring contents of a memory of said computer system to a non-volatile storage device under control of an operating system of said computer system and turning off a power circuit of said measurement instrument; and
in a case that said power switch is turned on in the hibernation mode, turning on said power circuit, transferring the transferred contents stored in said non-volatile storage device to said memory under control of the operating system and recovering said measurement device under control of application software and the data stored in said memory.

2. The method as recited in claim 1, further comprising the step of:
transferring the application software from said non-volatile storage device to said memory when the application software is used.

3. The method as recited in claim 1, further comprising the step of:
in a case that said power switch is turned on in a normal mode, turning on said power circuit, transferring the initialization data from said non-volatile storage device to said memory under control of the application software; and
initializing said measurement device under control of the application software and the data stored in said memory.

4. The method as recited in claim 1 wherein said computer system comprises a central processing unit, a random access memory and a hard disk drive.

5. The method as recited in claim 4 wherein said random access memory is used as said memory and said hard disk drive is used as said non-volatile storage device.

6. The method as recited in claim 1, further comprising the step of:
determining whether Tc−Tp<T+α is satisfied or not in the hibernation mode wherein Tc is a time when a current timer routine is executed, Tp is a time when a last timer routine is executed, T is a time interval and α is a margin;
if Tc−Tp<T+α is satisfied, determining the power switch is not turned off; and
if Tc−Tp<T+α is not satisfied, determining the power switch is turned off.
